(19) United States
(12) Patent Application Publication
(10) Pub. No.: US 2008/0202824 A1
(43) Pub. Date: Aug. 28, 2008

(54) Tilting Touch Control Panel

(76) Inventors: Harald Philipp, Drogheda (IE); Nigel S. D. Hinson, Lymington (GB); Christopher K. Ard, Chandlers Ford (GB)

Correspondence Address: DAVID KIEWIT, 5901 THIRD ST SOUTH, ST PETERSBURG, FL, 33705, US

(21) Appl. No.: 12/029,497

(22) Filed: Feb. 12, 2008

Related U.S. Application Data
(60) Provisional application No. 60/889,726, filed on Feb. 13, 2007.

(51) Int. Cl. G06F 3/041

(52) U.S. Cl. 178/18.01

(57) ABSTRACT

A control panel for controlling a device in response to user indications, the control panel comprising, a position sensing element (60) having a sensing surface, and a position interface circuit (76). The position interface circuit (76) is operable to determine a position of an object (100) on the sensing surface, when the object (100) is applied to the sensing surface of the position sensing element (60). At least one pressure sensing device (54, 66) and the sensing surface of the position sensing element (60) are arranged with the effect that a displacement of the sensing surface with respect to the pressure sensing device in response to the pressure applied by the object is detectable by the pressure sensing device. As such, in one example, the position interface circuit (76) is operable to identify one or more of a plurality of user indicated signals by correlating the position of the object on the sensing surface with a pressure detected by the pressure sensing device. The sensing surface may include pre-designated and pre-determined locations representing virtual buttons so that by determining whether the object is at one of a plurality of pre-determined locations on the sensing surface of the position sensing element, the position interface circuit (76) can identify the user indicated signal by correlating the position of the object at one of the predetermined locations with the detected pressure, each of the pre-determined location corresponding to one of the plurality of user indicated signals.

### FIELD OF THE INVENTION

The invention relates to control panels for controlling a device in response to a user's input, in particular the invention relates to a control panel having both touch sensitive and mechanical input means.

### BACKGROUND OF THE INVENTION

There is an increasing demand for compact and user-friendly control panels for many devices, for example for devices such as portable media players, digital cameras, mobile telephones and so forth. These devices are becoming smaller and are being provided with more functionality. To make best use of this increased functionality it is important that the control panel presented to the user (i.e. the user interface) is ergonomic, simple and intuitive to use, and allows the user to quickly access the functions of the device. There is also a demand for control panels which are both aesthetically pleasing and robust yet simple to manufacture.

It is known for control panels to include both touch sensitive inputs (e.g. capacitive position sensors) and mechanical inputs (e.g. conventional push buttons/switches). For example, the “iPod mini” manufactured by Apple Computer Inc. has a touch sensitive scroll wheel overlaying a number of switches.

FIG. 1A schematically shows in plan view an example of this kind of control panel. FIG. 1B schematically shows a section view of the control panel shown in FIG. 1A taken along AA′. A control panel 2 is mounted in a wall 4 of a device to be controlled. The control panel includes a capacitive position sensor 6 in the form of a ring and four conventional switches 8. These are coupled to appropriate control circuitry (not shown).

The capacitive sensor 6 is formed on a platform printed circuit board (PCB) 10. The platform PCB 10 and the capacitive sensor 6 are covered by an outer protective layer 14. The platform PCB 10 is tiltably mounted on a central support 12 so that it can move within an opening in the wall 4 of the device. The support 12 is attached to a base PCB 16. The base PCB 16 and the wall 4 are fixed together. The position of a user's finger touching over the sensor 6 is determined by the control circuitry and may be used to control the device.

The switches 8 are mounted on the base PCB 16 beneath the capacitive sensor 6. By mounting the switches behind the capacitive sensor instead of elsewhere on the device the footprint of the control panel is reduced. Each switch 8 comprises a deformable diaphragm 8B disposed over a central electrode 8A. Each diaphragm extends away from the base PCB 16 to a height at which it just touches the underside of the platform PCB 10. Switching action is achieved by deforming a selected diaphragm so that it contacts the central electrode 8A. This is done by pressing down on the capacitive sensor above the desired switch. This causes the platform PCB 10 to tilt about its central support 12 and compress the diaphragm of the selected switch to bring it into contact with its central electrode.

A user provides instructions through appropriate use of the capacitive sensor and the switches. For example, if the device is a portable music player and the user wishes to play a particular track stored on the device, the user might activate an appropriate one of the switches to display a listing of the tracks available, then run his finger around the capacitive sensor to scroll through the available tracks, and finally press another of the switches to start playback of the desired track. A center button is often included as well for additional forms of input to activate a function, as described in US Patent Publication 2003/0095096.

Although the control panel 2 shown in FIGS. 1A and 1B provides a compact and intuitive user interface, it has a number of shortcomings. For example, there is a gap 20 between the platform PCB 10 and the wall 4. This means the interior of the device is not sealed. Accordingly, dirt and liquid may enter the device and cause damage. In addition, the mechanical nature of the tilting mechanism is prone to wear and possible eventual failure. Furthermore, because the entire platform PCB 10 is free to tilt about its support, switches can be activated by accident, e.g. by pressing midway between them (which furthermore might activate more than one switch). Finally, the mechanism requires considerable finger motion to activate a function, because after performing a scrolling motion on the sensing surface the user must then locate a switch to press, causing the user to lift their finger and move it to one of the available switches. This action could also cause additional unwanted scrolling action since the user's finger often does not lift off the sensing surface in a purely perpendicular motion, resulting in an unintended menu selection.

Another kind of control panel is described in the applicant's patent U.S. Pat. No. 7,279,647 as shown in FIGS. 2A and 2B. FIG. 2A schematically shows in plan view a control panel 22 for controlling a device. FIG. 2B schematically shows a section view of the control panel 22 taken along BB′. The control panel 22 has an overall level of functionality which is similar to the control panel 2 shown in FIGS. 1A and 1B in that it includes a PSE 26 in the form of a ring and four switches 28.

The control panel 22 comprises a PCB substrate 36 carrying the capacitive sensor 26 and the switches 28, a surface panel 24 overlaying the substrate 36, and an outer protective flexible membrane 34. The plastic surface panel 24 is integrally formed in a wall of the device. The sensor 26 is in the form of an annulus and comprises areas 27 of conductive material deposited on the substrate 36. Four of the conductive areas have circular open regions 31 within which there is no conductive material. These open regions 31 correspond to the positions of the four switches. Within each open region 31 is a central electrode 28A which acts as a switched contact of the corresponding switch. An electrical connection 42 passes from each central electrode through the substrate 36 to allow the switched terminal to be connected to sensing circuitry.

The control panel 22 is connected to position sensing circuitry operable to determine a capacitance distribution within a sensitive area of the sensor. An object, such as a user's finger, in the vicinity of the sensor 26 affects the capacitance of each of the conductive areas differently depending on the position of the object within the sensitive area. Measurements of the capacitance to ground of the respective conductive areas are taken, and from the changes in capacitance caused by the presence of the object, the position of the object on the sensor is determined. A control signal representing this position is reported to a device controller which takes appropriate action to control the device.

Each of the four switches 28 comprises a deformable conductive diaphragm 28B disposed over a respective one of the central electrodes 28A. When the diaphragm 28B is in a relaxed state (i.e. no deforming force applied) it does not contact the central electrode 28A and the switch is in an open state. The diaphragms 28B each extend through their respective holes in the surface panel 24 so as to protrude above it. The flexible protective membrane 34 is in the form of a ring and is attached to the surface panel 24 within the recess in its upper surface so as to overlay the protruding diaphragms.

Switching action is achieved by a user pressing above the appropriate diaphragm 28B to compress it sufficiently to bring it into contact with its central electrode 28A, thus placing the switch in a closed state. This is done by pressing down on the flexible protective membrane 34 at the appropriate place. The circuitry is configured to respond to this by sending an appropriate control signal to the controller so that it can take appropriate action to control the device. This configuration has the advantage over the design of FIGS. 1A and 1B in that the surface can be completely sealed. However, the design still has the disadvantage in that the user must locate a switch with a finger after a scrolling motion which could result in an error in menu selection. Clearly, the design of FIGS. 2A and 2B can also incorporate a center switch underneath the surface 24 if desired.

The control panels illustrated in FIGS. 1A and 1B, 2A and 2B each consist of four switches which over time are subject to wear and tear and eventually break down. The number of switches provided also means that such control panels are more difficult to manufacture requiring additional manufacturing steps. Performance of both types is adversely affected by the requirement for the user to locate a switch to ‘enter’ a function after the scrolling selection is performed which can result in additional finger motion and errors.

Other control panel systems are known which allow a user to control a device. For example International patent application WO2006029974 discloses a system which includes a touchpad and means for determining the location of a point at which a user touches the touchpad. The system is further arranged to provide a user with mechanical feedback if a force applied by the user on the touchpad exceeds a certain value. This is achieved by moveably suspending the touchpad within a frame and detecting movement of the touchpad within the frame upon the application of pressure. The system does not disclose or suggest any arrangement in which a location of a point of contact and a pressure applied at the point of contact can be correlated. Furthermore, because the touchpad is physically separate from the frame, gaps are left which leave the touchpad and the frame vulnerable to penetration by dirt and liquid.

U.S. Pat. No. 6,239,790 discloses a touchpad assembly for providing a signal to a computer indicative of the location of pressure applied by an object touching the touchpad assembly. The touchpad assembly includes X and Y position and pressure sensitive layers formed from semiconductor resistance sensors. Although the arrangement can determine a position and a pressure applied by a user input, the system is complicated. Moreover, the system is concerned primarily with measuring a continuous range of input pressures and because the system is implemented using semi-conductor sensors, the range of detectable input pressures that can be accurately detected is limited.

US2007/0052691 discloses an input device, which includes a movable touchpad. The device includes means for determining a point at which a user touches the touch pad and means for generating a control signal representing the point at which the user touches the touch pad. A group of movement indicators detect the movement of the movable touch pad so as to generate a number of additional control signals, which indicate the movement of the touchpad. Although enabling both the position of a user input and the movement of the touchpad to be detected, this system does not enable the detection of an individual actuating pressure, which can detect a user input pressure above a pre-determined threshold value. Furthermore, the disclosed system requires a number of movement sensors to detect the movement of the frame, which can add to the cost and complexity of the input device as a whole. In addition, since the touchpad is physically separate from the rest of the device, gaps are left which leave the device vulnerable to penetration by dirt and liquid.

US2004/108995 discloses a system including a touchpad integrated with a display unit. The display unit is attached to a mechanical system which allows the display unit to be moved relative to a frame which contains the display unit. When a user touches the touchpad, the position and the pressure with which the touchpad has been touched is detected and the display unit is moved accordingly. As such the mechanical system provides an arrangement for moving the screen in a direction in which it is being pushed.

To address the short comings of the prior art documents mentioned above an improved control panel has now been developed.

### SUMMARY OF THE INVENTION

According to a first aspect of the invention there is provided a control panel comprising a position sensing element (“PSE”) coupled to a position interface circuit (“PIC”) operable to determine the position of an object applied to the PSE, and at least one pressure sensing device (“PSD”) below the PSE, wherein the PSD responds to user pressure applied at multiple locations on the user-operable user surface. The PIC or the end application determines the nature of the user's pressure input; for example by interpreting the pressure sensed by the PSD as an ‘enter’ or ‘make it happen’ function correlated with a user feedback display such as a menu item on an LCD, without the need for moving or lifting a finger off of the PSE to a discrete button location. The PIC can also provide this correlation by having knowledge of the user's finger location at the moment of a PSD pressure increase.

Thus according to the first aspect of the invention, in one example, the pressure event in which the object is applied to the sensing surface of the PSE with a pressure, which exceeds an activation pressure threshold, can be detected by the PSD even though the object is applied at any arbitrary position on at least part of the sensing surface of the PSE. In some examples, the PSE is displace-ably mounted with respect to the PSD so that pressure applied by the object above the activation threshold causes the position sensing element to be displaced with the effect that the pressure event can be detected by the pressure sensing device. Another aspect of the invention includes a user controlled device having a control panel according to the first aspect.

The PSE may be impedance-based, for example capacitive or force sensing resistive (“FSR”), or non-impedance based such as optical or acoustic methods. It is preferred that the sensor layer is a capacitive PSE capable of interpreting a user input as either a one or two dimensional touch location depending on the requirements of the application. Both relative and absolute position measurements by the PSE are acceptable in various embodiments. These sensor types are well known in the art and are not described in further detail herein.

The PSD may be a deformable dome switch providing a galvanic contact closure upon being compressed which can be read by the end application processor or by the PIC. Conveniently this type of PSD can provide the user with a mechanical click feedback upon being pressed. Other types of PSD can be employed, for example a FSR, optical interrupter, piezoelectric crystal, or capacitive switch operable by sensing two conductive plates moving relative to each other at the moment of pressing. Such non-galvanic types of PSD have the advantage of high longevity, since they do not suffer from corrosion, oxidation, or moisture effects which can affect the reliability of the PSD. However if the PSD does not provide a click feedback to the user, a haptic device may be used to provide a mechanical feedback such as a shaking or impulse motion upon the user's pressure input to the PSD.

A ‘deformable dome switch’ should be interpreted to mean any type of switch of any composition without limitation, for example metal dome switches, conductive rubber domes, conductive plastic domes, tact buttons, membrane buttons, or other electromechanical switching devices, with or without tactile feed back.

The control panel may further comprise a substrate or support in which the PSE is mounted thereon. The PSD may be positioned below the support and is arranged to change between an open state and a closed state by pressing and de-pressing the PSE mounted on the support.

The control panel may further comprise means for holding the support on which the PSE is mounted within the control panel. The control panel may also comprise means for controlling displacement of the support, such as for example spring means, between positions in which the PSD is in an open state and a closed state. In a preferred embodiment, the means for holding and controlling displacement of the support are unitary.

The control panel may comprise a flexible or deformable surface panel overlaying the PSE, and with the PSE overlaying a PSD via a mechanical structure such as a moving platform. Furthermore, the control panel may additionally comprise a protective flexible membrane overlaying the surface panel. This provides for a control panel having an outer surface which is in effect sealed but still allows for activation of the PSE and the PSD. Sealing may also be provided using gasketing around the perimeter of the movable portion of the device.

The PSE can be arranged along any desirable path, for example, a closed path such as a circle or an open path such as a line or curve. Similarly, the PSD may be positioned at a location under the PSE as desired. Furthermore, the control panel may be provided with additional mechanical or touch sensitive switches outside of the sensitive area of the PSE.

The control panel of the invention may be in the form of a rotary panel (i.e. the PSE is arranged in a circle or curve such as a half-circle or an omega shape), a tilt pad or track pad (i.e. the PSE is arranged to have a square, rectangular, oval or other suitable shape). A capacitive PSE may be comprised of single or multiple conductive electrodes, e.g. copper, carbon, or clear Indium-Tin-Oxide (ITO) electrodes, arranged in a predetermined way. An ITO based capacitive PSE can be used to provide for a transparent or translucent PSE which can be backlit or placed in front of a graphical display such as an LCD or LED display. Thus, the PSE may be arranged to be opaque or substantially transparent depending on the application of the device incorporating the control panel.

In embodiments of the invention, the PSD used may be arranged to be single force or dual force. If the PSD is single force, then applying a force sufficient to change the state of the PSD will activate a required mode or function (such as “enter” or “make it happen”) of the device incorporating the control panel. If the PSD is dual force, then applying a force sufficient to cause a first or ‘initial’ pressure input followed by an additional force or press on the PSE to cause a second or ‘final’ pressure input, two functions or stages of a function may be controlled on the device. An example would be where a user scrolls to a menu item or function using the PSE surface, then presses lightly to activate the first pressure input stage causing a ‘preview’ of the selected function; an even harder user pressure can then ‘make it happen’. A controller can interpret the signals from the PSD to determine the function or operation required based on the operating software used in the particular device.

The PSD may allow for displacement during a pressure event, for example a tactile dome will compress under pressure providing a click feedback feel. However the invention can also employ non-displacement type PSD's such as FSR's and piezoelectric sensors; these types of PSD do not offer a tactile click feeling but can provide for a mechanism that offers better panel sealing against moisture and dirt. Tactile feedback in these cases can comprise a haptic transducer which is responsive via the PIC to provide a click or shaking response to the user.

The control panel of the invention may be incorporated into consumer electronic devices, such as for example, mobile telephones (cell phones), portable media players (MP3 players), digital cameras and so on to control different operating functions of the devices. The control panel of the invention may also be a ‘standalone’ device or peripheral to a main device, e.g. a computer. In such embodiments, the peripheral device is electronically connected to the main device, wirelessly or by cable, to control a cursor or other function on the display of the main device. In one preferred embodiment of the invention, the control panel may operate as a mouse or other input device to a PC.

According to another aspect of the invention there is provided a control panel for controlling a device is response to user indications, the control panel comprising, a position sensing element having a sensing surface, and a position interface circuit. The position interface circuit is operable to determine a position of an object on the sensing surface, when the object is applied to the sensing surface of the position sensing element. The control panel includes at least one pressure sensing device. The pressure sensing device and the sensing surface of the position sensing element are arranged with the effect that a displacement of the sensing surface with respect to the pressure sensing device in response to pressure applied by the object is detectable by the pressure sensing device.

In one example, the position interface circuit is operable to identify one or more of a plurality of user indicated signals by correlating the position of the object on the sensing surface with a pressure detected by the pressure sensing device. The sensing surface may include a plurality of pre-determined locations, which may represent virtual buttons so that by determining whether the object is at one of the plurality of predetermined locations on the sensing surface of the position sensing element, the position interface circuit can identify the user indicated signal by correlating the position of the object at one of the predetermined locations with the detected pressure, each of the predetermined locations corresponding to one of the plurality of user indicated signals.

Various further aspects and features of the present invention are defined in the appended claims, which include a user controlled device, a method of controlling a device and a method of identifying one of a plurality of user indicated signals.

### BRIEF DESCRIPTION OF THE DRAWINGS

For a better understanding of the invention and to show how the same may be carried into effect reference is now made by way of example to the accompanying drawings, where like parts have the same alpha-numeric designations and in which:

FIG. 1A schematically shows a plan view of a known control panel;

FIG. 1B schematically shows a section view through the control panel shown in FIG. 1A;

FIG. 2A schematically shows in plan view a known control panel;

FIG. 2B schematically shows a section view through the control panel shown in FIG. 2A;

FIG. 3 and FIG. 4 schematically show sectional views of a control panel according to an embodiment of the invention;

FIG. 5 schematically shows a plan view of part of the control panel shown in FIGS. 3 and 4;

FIGS. 6, 7, and 8 schematically show sectional views of a control panel according to another embodiment of the invention under applied pressure;

FIG. 9 schematically shows in sectional view a control panel having a sealed upper surface, under pressure;

FIG. 10 schematically shows in sectional view a control panel having a sealed lower surface;

FIG. 11 schematically shows in sectional view the control panel of FIG. 10 under pressure, and additionally showing a connection method;

FIG. 12 schematically shows in sectional view a control panel having mechanical index points;

FIG. 13 shows the control panel of FIG. 12 in plan view;

FIGS. 14a through 14d show plan views of the control panel having different outline shapes, coordinate systems for operation, and the use of virtual buttons;

FIGS. 15a, 15b, and 15c show in sectional view one form of dual pressure sensing under different states of compression;

FIGS. 16a and 16b show an alternate, more compact form of construction of the control panel with two configurations of electrical connections and two methods of pressure transfer to a pressure sensor;

FIG. 17a schematically shows in sectional view a control panel optimized for thinness and placed above an optional graphic display;

FIG. 17b shows in plan view the outline of the PSE of FIG. 17a;

FIG. 18 shows a graph of the pressure on the pressure sensor versus lateral displacement from the sensor's location;

FIG. 19 shows an electrical block outline of the apparatus; and

FIG. 20a is an illustrative representation of a mobile personal computer, which has been adapted to include a touch sensor according to the present technique showing example keys on the personal computer's keyboard;

FIG. 20b is a corresponding example showing a different set of keys; FIG. 20c is a further corresponding example for a different set of keys; and FIG. 20d provides an illustrative example in which a touch sensitive control pad of the personal computer's control panel is implemented using a touch sensor according to the present technique.

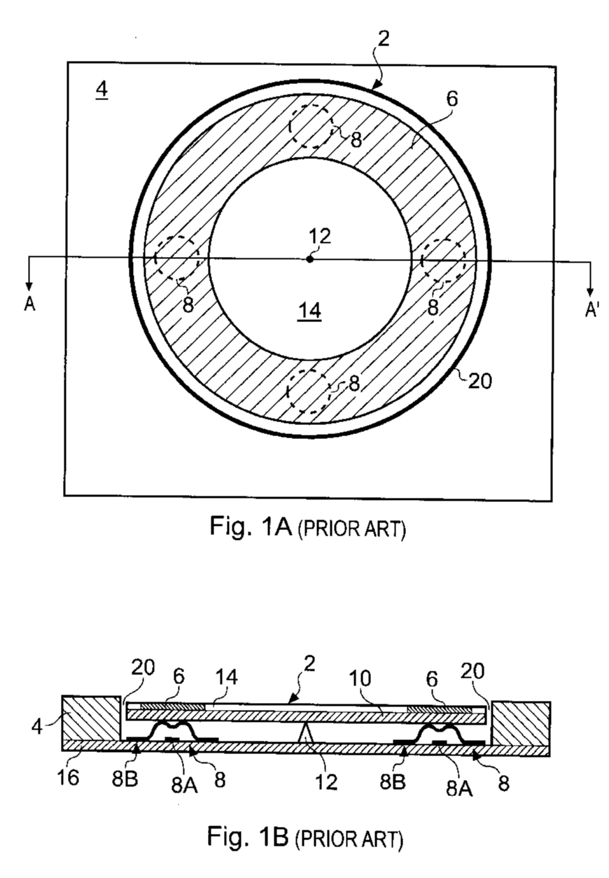

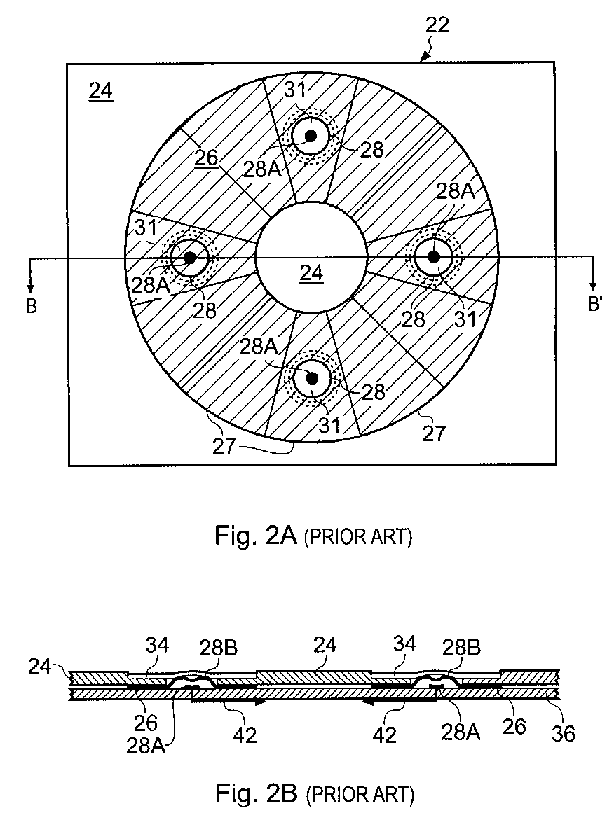

### DESCRIPTION OF EXAMPLE EMBODIMENTS

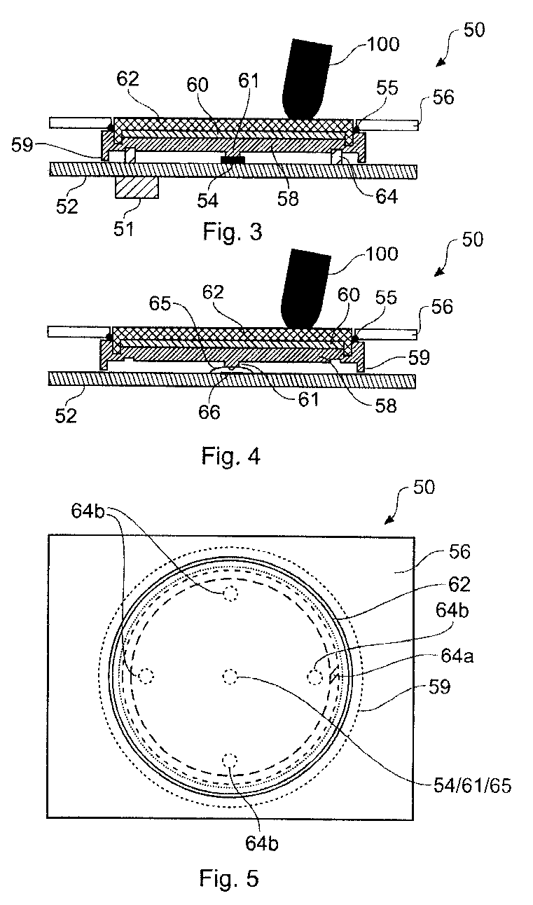

FIG. 3 schematically shows in section view a control panel 50 for controlling a device, e.g. a portable music player, mobile telephone, or any other appliance, according to an embodiment of the invention. A PSE 60 of any operable basis in physics (such as capacitance or other form of impedance measurement, optical, acoustic, piezoelectric etc) lies under a user surface 62, said surface being designed to be touched and pressed by a user. Rigid carrier plate 58 is supported by resilient material 64 which is compressed under pressure between 58 and PCB 52 on which the assembly is supported. Electrical, optical or acoustic connections to 60 are not shown. Travel limiter appendage ridge or posts 59 extends below the assembly to prevent damage to the assembly from over-pressure. A PSD 54 is compressed by appendage 61, which acts as a force concentrator, when the user 100 applies force anywhere along surface 62.

Optional seal 55 provides a moisture and dust barrier to the assembly; other forms of sealing will be shown in later figures.

In practice PSD 54 can be any pressure sensing device such as an FSR, or, as shown in FIG. 4, a deformable dome switch 65. If 65 provides an abrupt flexure under pressure, the user 100 will feel and even hear a distinct ‘click’ response which travels up through post 61 to the control surface 62, giving a pleasing indication of pressure feedback. In fact the assembly surface itself has been found to act as a form of speaker diaphragm, transmitting the sound of the click to the user in a seemingly amplified form. If the PSD has little or no intrinsic travel and cannot produce a tactile and/or audible feedback response of its own accord, then an optional haptic device 51, such as a solenoid, speaker, piezoelectric transducer or other moving mass device can be triggered by the PIC to provide such mechanical and/or acoustic feedback to the user.

Switch dome 65 as shown can be a galvanic type, whose output is fed to the PIC 76 (FIG. 19) or directly to the logic of the appliance 82 to which the apparatus 50 is connected.

Compressible material 64 applies a restorative force to the assembly and thus slightly resists the user's finger pressure. Material 64 can be a ring of material around the total assembly 64a (FIG. 5), or can be multiple discrete pillars of material 64b in one or more places. If implemented with discrete pillars of material, the pillars can also be metallic or plastic springs. If a spring type tact dome is used for PSD 54, as in 65, then additional material 64a or 64b may not be required since the spring force is provided by the PSD (eg dome) itself. In some cases spring material might still be required to aid the force of a dome 65, for example if the diameter of surface 62 is large, or has a large mass requiring additional resilient support, or if the PSD does not otherwise have enough spring force of its own accord.

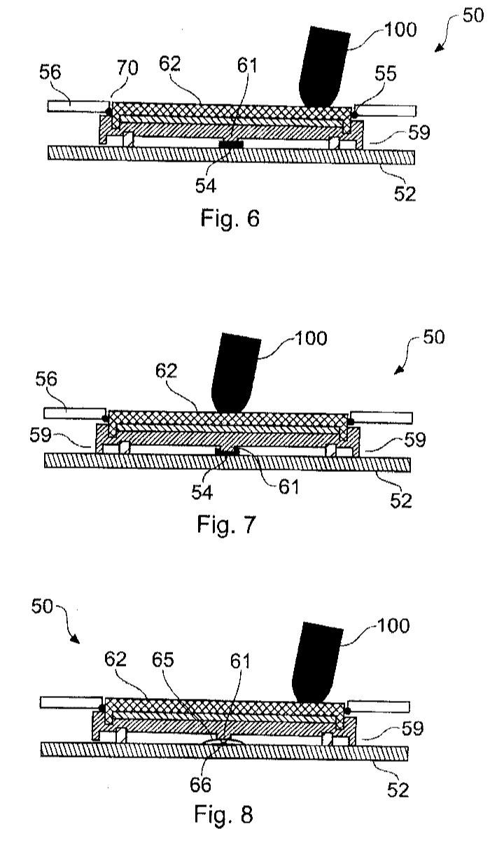

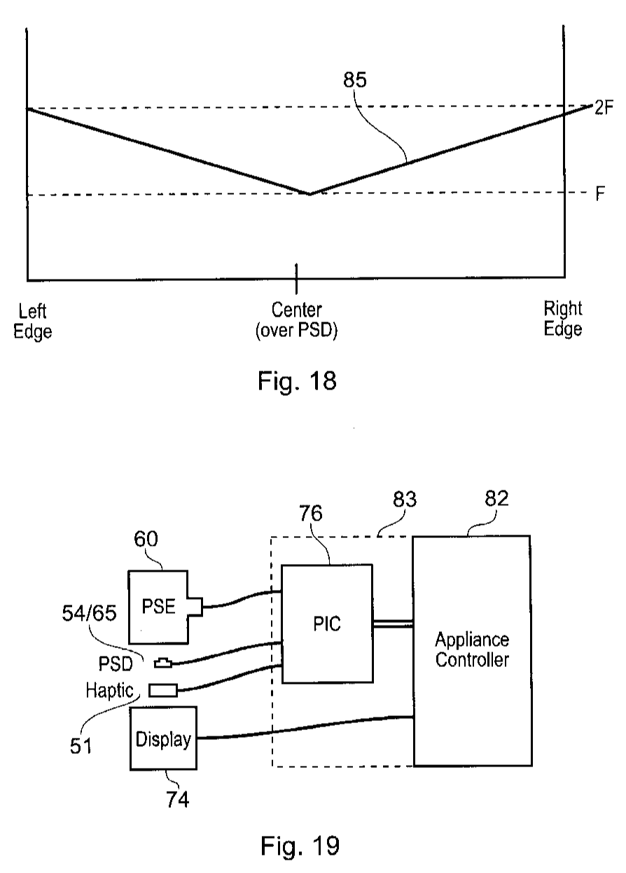

FIG. 5 schematically shows a plan view of the control panel 50 from the user's perspective (above). In particular, compressible material 64a is shown in this view as a ring of material under the control surface or as pillars 64b. User input can be affected across the entire surface within 62 using known PSE methods as described supra. Pressure to effect the PSD 54 can be applied anywhere across surface 62 since the mechanism is mechanically isolated from the rest of panel 56. Due to the leverage effect of the surface as shown in FIGS. 6 and 8, the force required to activate the PSD is not equal in all locations, being rather greater over the surface above the center in the case of FIG. 4, by as much as a factor of two. Likewise, finger push-travel displacement near the edges can be twice as much as at the center to effect the PSD. This is described later in conjunction with FIG. 18.

Turning now to FIG. 6, we see the effect of user pressure applied to the control surface 62 to the assembly near one edge, off-center from the PSD 54. If this pressure is applied as shown, the surface 62 tilts down towards one side as shown, allowing post 61 to compress PSD 54. The point 70 is the pivot point of motion, being on the distal edge of the movable mechanism at the interface between the rigid member 58 and surrounding panel 56. FIG. 7 shows the effect when the pressure is applied at the center of the surface 62, directly over PSD 54. Here, the entire surface moves down as shown to apply force to the PSD 54, with no particular pivot point. Thus, it can be seen that with a single PSD, it is possible to effect a sensing surface having both a large PSE with activation pressure variations of only 2:1. In tests, this activation pressure variation is noticeable but not annoying. FIG. 8 shows same effect as in FIG. 6, but with a tactile dome switch 65 compressing onto a contact surface 66 to create an electrically readable contact closure.

Dome 65 and contact 66 can optionally be of a capacitive type, whereby the surface of contact 66 or the lower surface of dome 65 is covered in a dielectric material so that no galvanic connection is relied upon. Sensor circuitry is required to read this change in capacitance; uniquely, this form of switch has extremely long life since the contact surfaces cannot degrade, since there is no galvanic contact. If the PIC is a capacitive readout type and the PSE is a capacitive layer, adding a single additional capacitive sensing channel for a capacitive PSD is a simple, cost effective method. If the change in capacitance due to the collapse of such a dome is large, then the readout of the capacitive spike can also be accomplished by feeding this signal into an existing channel of the PIC used to read out one of the PSE channels.

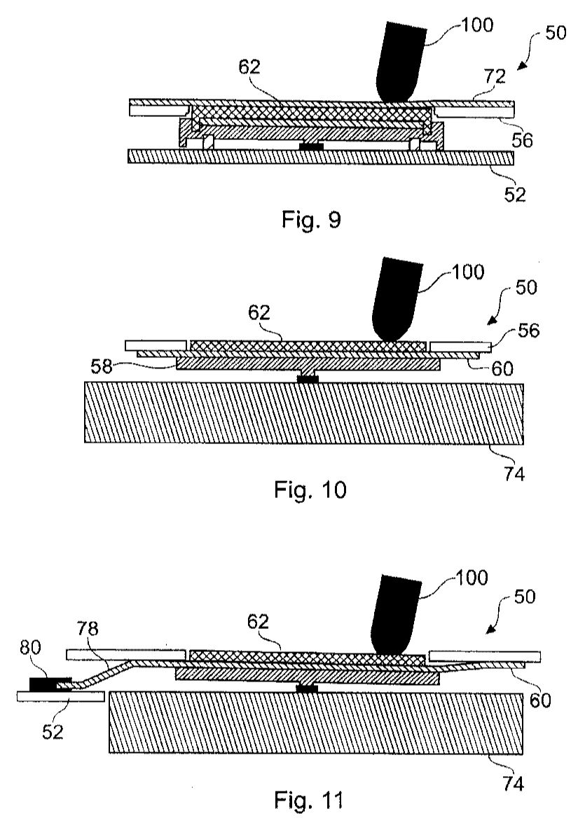

FIG. 9 shows the use of a sealing membrane surface 72 adhered to the top surface, instead of sealing gasketing 55. Such a surface can be used for the decoration layer as well, with 72 being glued to the surfaces 56 and 62 in a way to allow some freedom of movement of the moving mechanism of the device, as shown. If the movement of the device under pressure is slight, then over time and usage the flexure of 72 should not cause permanent deformation. This is particularly true with PSD types that do not involve much displacement under pressure, such as piezo or FSR transducers, where the required flexure of membrane 72 would be minimal.

FIG. 10 shows the sealing of the device being accomplished under the panel 56 using the PSE 60 itself as a seal, which is adhered using an adhesive layer (not shown). In this case, the PSE 60 can traverse not only the sensing zone under the mechanism surface 62, but also regions under the panel 56, for example to sense finger motion across a broader panel with a single sensing layer 60. Such a configuration is particularly useful when the entire control surface including regions 62 and portions of 56 lie above a graphic display 74. In such a case, the PSE and all its support structures and surfaces 62 and 58 can be made of a clear material to allow light transmission of the display. In this way, a pressure sensitive input surface can be made interactive with graphic symbols displayed for example on an LCD or other optical display type, leading the user to employ surface 62 in a more interactive way with the appliance being controlled. Materials for 60 can include clear PET film with coatings of ITO or PEDOT for the sensing surface areas as is well known in the trade. PSE 60 can be of single or multilayer type as will be obvious to the practitioner depending on the nature of the sensing effect required and the sophistication of the PIC.

As shown in FIG. 11, a PSE 60 can be designed to flex slightly under pressure applied to the surface 62 in much the same manner as the layer 72 can flex from above. Additionally shown in FIG. 11 is the tail section 78 of PSE 60 and a connector 80 on the PCB 52 which similarly flex under defection caused by finger 100. Not shown in FIGS. 10 and 11 is the use of travel limiters 59 or resilient spring material 64. It should be seen as obvious to the practitioner to use these items in conjunction with any of the diagrams of this disclosure depending on the particular needs of the actual implementation.

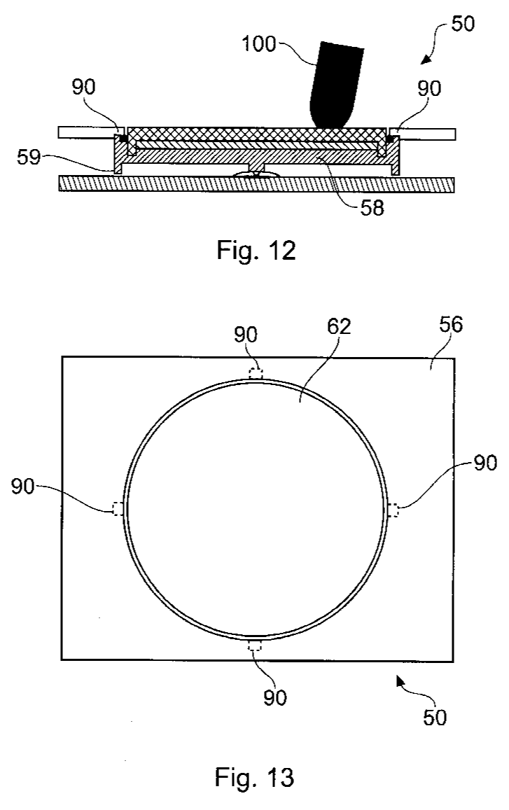

One problem with the implementations of FIGS. 3 through 11 as shown is that if they are implemented as circles, the mechanism can tend to twist or rotate under action from a scrolling or wiping motion of finger 100 upon the user surface. To counteract this, in FIGS. 12 and 13 are shown detents 90 which cause a circular shape to remain locked in place to prevent unintended rotation. These detents are preferably hidden from view. They are easily formed from tabs of material from carrier plate 58 which fit into recesses moulded into surface 56 on the interior of the panel. It should be seen as obvious to the practitioner to use such detents in conjunction with any of the diagrams of this disclosure depending on the particular needs of the actual implementation.

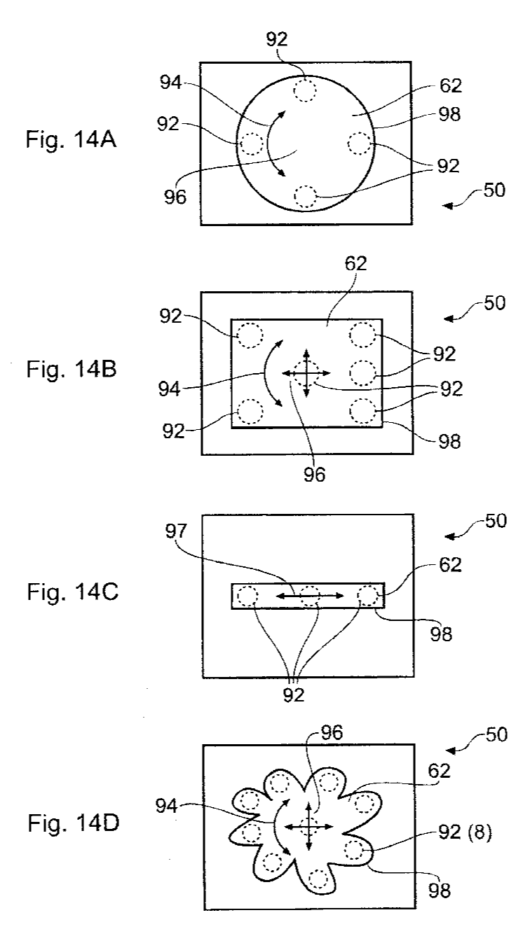

FIGS. 14a through 14d show, without limitation, various surface shapes of the apparatus. In 14a is shown a classic circular shape. User action thereupon can be either circular 94 (ie ‘iPod style’), or Cartesian 96. As with any user scrolling interface device, any type of motion such as gestures, scrolling action, absolute sensing, relative pointing motions, taps and double taps, taps and scrolls, etc can be used on the surface without any limitation. If the PSE extends beyond the apparatus, as shown in FIG. 10 and 11, then such motions can even extend to include areas beyond the perimeter of surface 62. Additionally, virtual buttons 92 can be formed on surface 62 which can be graphically marked using a printing process or formed using an image from a display device 74 underneath the mechanism, as per FIG. 10. In usage, locations 92 can be first lightly touched by a user to stimulate a first appliance reaction, ie a ‘pre-press’, after which the user can press at the same location to cause an appliance input via PSD 54/65 to ‘make it happen’ or ‘enter’ for example.

Button locations 92 can be virtual in the sense that they do not correspond to actual buttons or any particular mechanism, rather, they are simply located via the coordinate information provided by the PSE 60 and interpreting PIC logic 76 (FIG. 19). Alternatively, the buttons 92 could be actual discrete sensing areas formed from capacitive electrodes or FSR material or optical sensing which are fixed in nature. In fact the PSE 60 does not have to report arbitrary coordinates as assumed in most of this disclosure; the use of discrete sensing areas without coordinate reporting is a viable and simple alternative in a variety of applications which may serve to lower cost. Thus areas 92 can be either fixed or interpreted yet remain within the spirit and scope of the invention.

FIG. 14b shows a rectangular sensing area which can also report discrete buttons, virtual buttons, angular inputs, Cartesian inputs, or any combination as would be the case with FIG. 14a.

FIG. 14c shows a linear or one-dimensional sensing surface 62, which shows that the surface 62 is not restricted to two-dimensional surfaces. This configuration is known in the trade as a ‘slider’ but in practice the surface can be used for either tapping or sliding motions. Again, virtual or discrete buttons 92 may be formed thereon depending on the application requirements. The device of FIG. 14c can be seen as a slice of FIG. 14b, and as such, the mechanism underlying it can be the same as the others.

FIG. 14d shows that the sensing surface 62 can in fact be totally arbitrary in shape and is not restricted to neat geometrical patterns. Such arbitrary shapes are useful in certain constrained applications or for children's toys. Again, buttons can be formed thereon as described supra.

In general, one or more positioning sensing elements having sensitive areas arranged along any path, closed or open, or two-dimensional area can be used. Furthermore, the control panel need not be flat, but may be contoured, e.g. in the form of a simple or complex curve, so as to provide a shaped outer surface, e.g. to follow the lines of a device to be controlled.

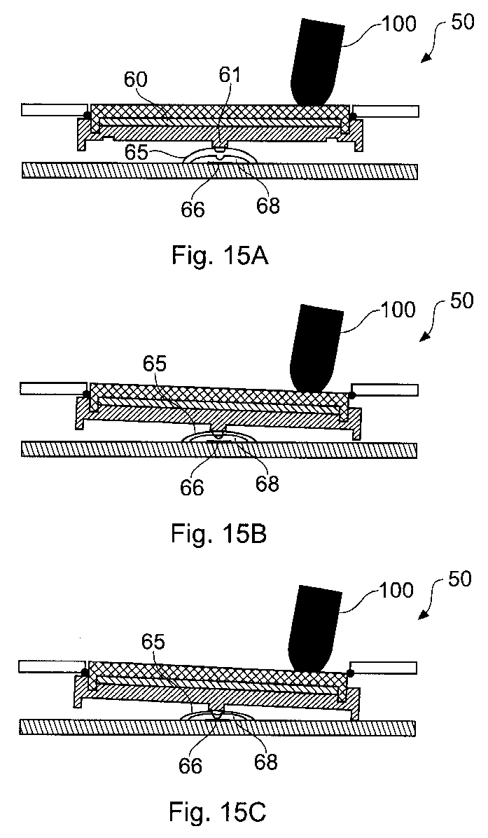

FIGS. 15a through 15c show the use of a two-stage user-pressure action. Such an action is well known in digital still cameras (“DSC”) where a pre-press is used to trigger a focus and adjustment stage, and then a yet harder press is used to trigger the image capture. Such two stage mechanical action can be quite useful in the invention because it can be used to give greater control or convey more information to the user prior to a ‘make it happen’ or ‘enter’ final push of the mechanism. One way of implementing this is with a dual-dome structure as shown. A first light pressure (ie touch) applied in 15a by finger 100 causes a reaction from PSE 60 alone. A second stronger pressure applied in 15b causes the outer dome 65 to collapse into inner dome 68, the resulting contact of which triggers a first appliance action (such as ‘preview’ or ‘focus’). A yet harder pressure shown in 15c causes the inner dome to also collapse, the detection of which by the PIC or appliance causes the ‘make it happen’ or ‘enter’ function to occur.

A second way to implement this type of action is to use the mechanism of FIG. 3. Here, the PSD is a FSR or similar non-mechanical sensing device which has an analog output. The PIC can interpret two or more levels of pressure quite easily from the electrical response to the applied pressure. The PIC or the appliance can in turn perform the kind of reactions described supra in response to these pressure levels, and since the PSD in FIG. 3 does not necessarily provide tactile feedback, an optional haptic device 51 can be employed to cause the desired tactile click response when driven by the PIC or appliance.

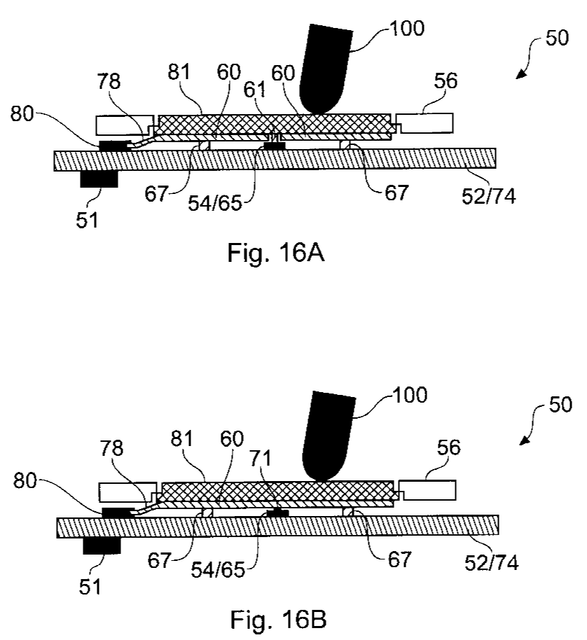

FIG. 16a shows yet another mechanical configuration which is simpler than those of the prior figures such as FIG. 3. This mechanism uses only one rigid plate 81 to form the user surface (although it could be covered with a membrane 72, as shown in FIG. 9) and an underlying PSE layer 60. Protrusion 61 applies a point concentration of force onto PSD 54/65 as shown. Either a PCB substrate 52 or a graphic display 74 as shown in FIG. 10 can be used under the assembly. Tail 78 connects the PSE to a connector 80; alternatively these connections can be made via conductive, compressible pillars 67 suitably placed. This diagram can obviously be combined with compressible material 64 and travel limiters 59. However this particular assembly implementation can be made extremely thin, and so it could be that the lower corner edges of 81 could simply contact the surface of 52/74 when pressed to limit its travel.

FIG. 16b shows a slight modification of 16a, wherein the pressure concentrating protrusion 61 which is shown attached to the plate 81 is eliminated. Instead the PSD 54/65 has its own pressure concentrator 71 which serves to focus pressure on the PSD while also acting as a fulcrum for the motion of part 81.

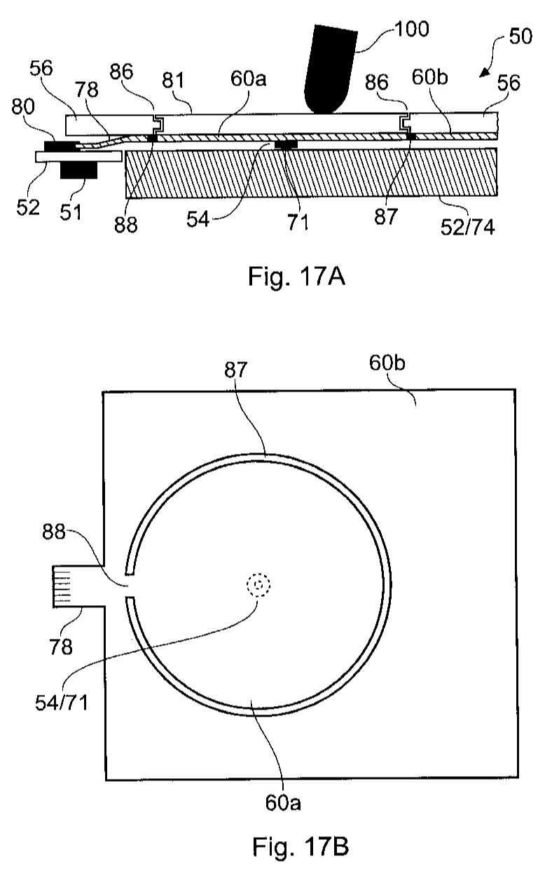

FIGS. 17a and 17b show a preferred embodiment, where the PSE 60a is adhered to the underside of the sensing surface 81. To achieve a wider scope of usage for the PSE, the PSE is extended to regions outside of surface 81, 60b. If the PSE is transparent (e.g., made from ITO or PEDOT coated clear PET film) then a display 74 can be used where normally would be a PCB 52. To facilitate the most cost effective and simplest construction of the apparatus, the PSD 54 is incorporated by attachment to the PSE rather than a surface of 52 or 74, with appendage 71 being upside down as shown to focus the pressure appropriately, as may be required; if the PSD 54 is small in diameter, appendage 71 may not even be required. Connections to the PSD 54 are therefore contained within sensing layer 60a. A tail 78 leads from the PSE to a connector 80. An optional haptic device 51 may be used for feedback, especially if the PSD 54 provides little or no tactile or acoustic feedback.

Depending on available materials, the PSD 54 itself can also be made transparent, or so small in diameter as not to materially interfere with the viewing of a display 74. If the PSE is a capacitive sensing type, then the PSD could also be capacitive, relying on compression of two conductive plates towards each other through a compression zone, which could be merely a small air capsule or small piece of foam, perhaps optically clear. The PSE 60a can be made easier to flex by cutting an annular ring out of it as shown in FIG. 17b, at 87. Region 88 is an electrical and mechanical attachment point for the film 60a to 60b, so that it can be applied easily using standard lamination methods to the surfaces 81 and 56. Region 88 needs to be flexible so that it does not break down under repeated flexure from user inputs. While shown in FIG. 17b as a plain flat connection region, it is well known to mechanical designers to make such a region 88 using a zig-zag or meandering lateral path to increase the effective path length, thus reducing stress on the area. To facilitate assembly, such regions 88 may be used in 2, 3, 4 or more places around the periphery of 60a to hold the film in place during the step of adhering it to the panel 56 and surface 81. Sealing if desired can be accomplished in a variety of ways, some of which have been discussed supra, such as the use of a gasket. Finally, the travel limiter function 59 of FIG. 3 is shown built into the edge molding of the panel 56 and surface 81, so that they can snap together during assembly yet provide an appropriate mechanical travel limit during use. This construction can also incorporate an anti-rotation mechanism such as 90 at one or more points around the circumference, if the surface is actually round as shown.

It should be clear to the practitioner that a great many combinations of the foregoing mechanical drawing elements are possible depending on the requirements of the design and the cleverness of the individual designer. Any of the elements shown in any figure can be combined with other figures described herein to arrive at specific solutions, however all such combinations should be seen to be within the spirit and scope of the invention.

FIG. 18 shows the response of an analog PSD when centrally located under surface 62 or 81, without the aid of additional resilient support structures such as material 64 (FIG. 3). This graph shows the amount of reported pressure with respect to an actual user applied pressure of a certain fixed amount, as applied from left to right across the surface of the apparatus. At the point just over the PSD, ie the location designated ‘center’, the reported pressure is ‘F’. However, at the edges (designated ‘left’ and ‘right’) the reported pressure is 2 F, due to the mechanical advantage of the mechanism as it tilts. What this means to the user is that it is twice as difficult to activate a PSD in the middle as it is at the edges. As described above this pressure variation is with acceptable norms for most users however can be improved as follows.

The use of an analog-responding PSD (such as a FSR) provides an opportunity to linearize this pressure response by setting the activation pressure threshold dynamically depending on where the pressure is applied on surface 62. Fortunately, the exact location of pressure can be known since the PSE 60 and PIC 76 can ‘know’ the finger location relative to the PSD location, and hence can adjust the pressure threshold required to activate an end-function. In this case, the compensation curve applied with respect to displacement from the PSD looks the same as the solid line 85, that is, a higher pressure is required for activation at the edges than at the center, by a factor of two. The haptic device 51 can be used to provide the required user tactile and/or acoustic response when this threshold is exceeded.

In many applications a FSR or other similar material for the PSD is desired since such materials can be screen-printed and are only some microns thick, as opposed to tact or dome switches which are mechanically thicker. In mobile phones for example, this would be a considerable advantage and may not even cost more (although a haptic device which is likely required with a FSR does cost extra).

FIG. 19 shows a diagram in block form of the overall circuitry of the appliance. PSE 60 comprises a sensing layer being responsive to, without limitation, Cartesian, polar, angular, radial, linear, relative, gesture, tapping, or absolute inputs, and/or one or more discrete touch areas. A PSD 54/65 comprises a pressure sensing transducer which may have either a discrete or analog output and which may be made from, without limitation, any compressible material in any shape which can respond in a predictable way to an applied pressure. An optional haptic device 51 can provide acoustic or motion response under the control of either the PIC or the appliance and can comprise without limitation a solenoid, speaker, piezo element, motor, or other moving mass transducer responsive to an applied power source. Optional display 74 can provide graphical displays to the user and when placed under the device can be used to allow the user to interact with the invention in a more arbitrary manner. A PIC 76 is used to read at least the PSE and possibly also the PSD for interpretation and transfer to the appliance controller 82. While FIG. 19 shows one fixed configuration, the practitioner will understand that other wiring are equally possible. For example, the PIC can be subsumed within controller 82 (shown dotted 83). Elements 54/65 can be read by and haptic device 51 controlled by controller 82 instead of via PIC 76.

It will also be understood that any form of capacitance measurement circuitry, if such is used to read out PSE 60, may be employed. A preferred capacitance measurement circuit is of the charge-transfer kind described in the applicant's U.S. Pat. No. 6,466,036. This type of circuitry provides for a reliable and robust measure of the typical capacitances that might be expected in a given implementation of the invention. However many other capacitive circuit types can be employed as well and do not affect the scope or spirit of the invention.

Finally, it is noted that although the term “touch” is frequently used in the above description, a PSE can be sufficiently sensitive that it is able to register the location of an adjacent finger (or other object such as a stylus) without requiring physical contact. The term “touch” as used herein should therefore be interpreted accordingly.

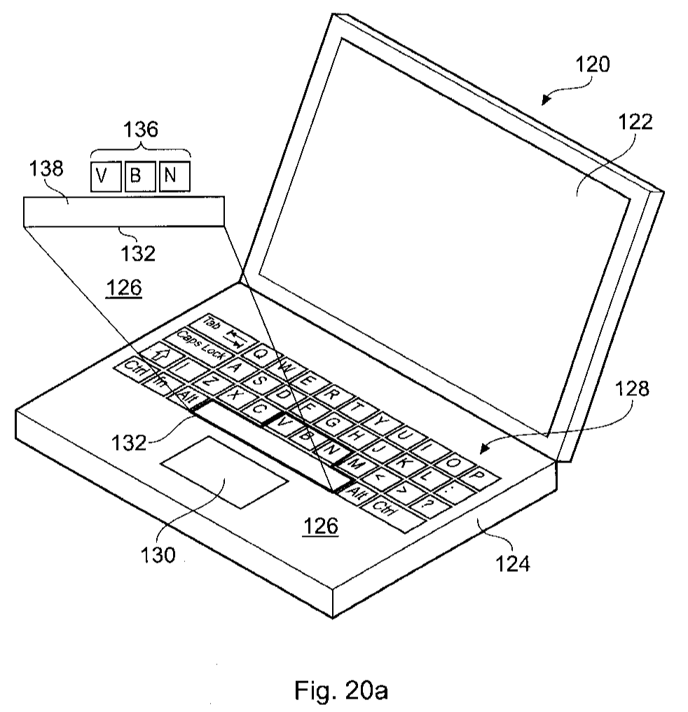

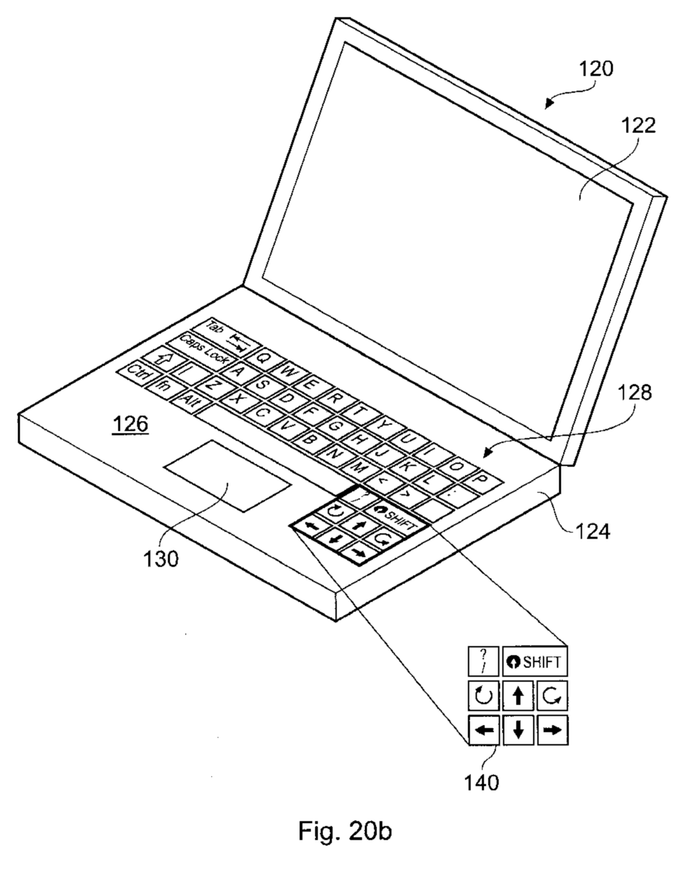

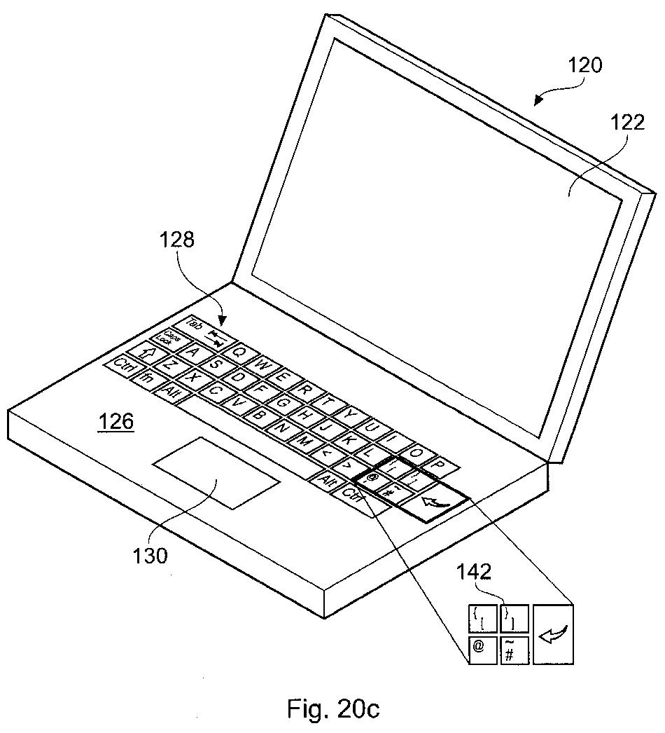

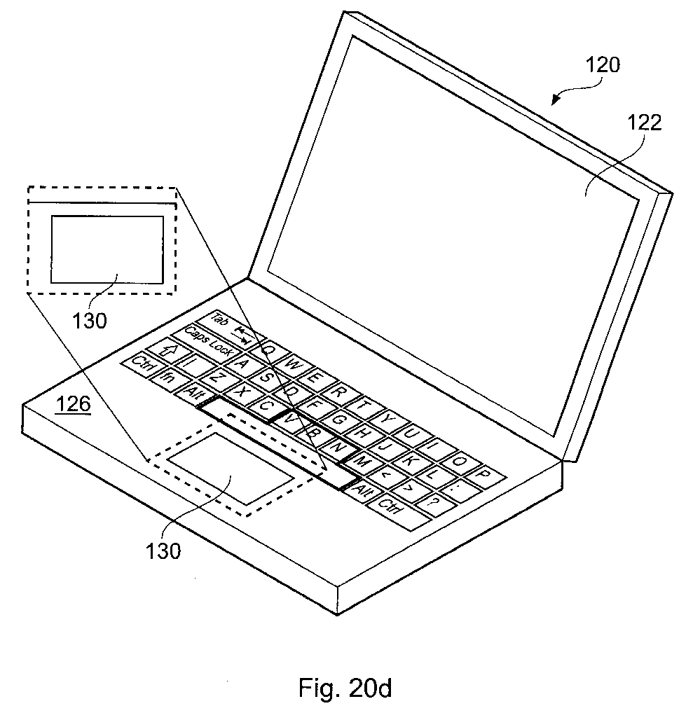

Further example applications of the present technique can be envisaged. For example, a touch sensor according to any of the examples described above could be used to implement or form part of a touch sensitive control panel for a personal computer or a mobile personal computer. An example of a mobile personal computer 120 or notebook PC is shown in FIGS. 20a, 20b, 20c and 20d. A touch sensor according to the present technique could be used to form part or the whole of an input control panel of the notebook PC 120. In FIGS. 20a, 20b, 20c and 20d the notebook PC 120 is shown, which includes a display device 122 attached to a base 124, which includes a processor and other components typically associated with a PC. As shown in FIG. 20a, an input control panel 126 includes a “QWERTY” keyboard 128 and a touch sensitive mouse pad 130. As will be appreciated from the explanation provided above, various parts or the whole of the keyboard 128 and/or the touch sensitive mouse pad 130 could be implemented using a touch sensor or sensors according to the present technique. FIGS. 20a, 20b, 20c and 20d illustrate different examples.

As shown in FIG. 20a a particular key grouping 132 is shown as an exploded view 134. The key grouping includes the V B N keys 136 and the space bar 138 of the QWERY keyboard 128. The key grouping could be implemented as part of a touch sensor according to the present technique. Similarly, FIG. 20b provides an exploded view a different example key grouping 140, which includes arrow and shift keys, and FIG. 20c provides an exploded view of a different example key grouping 142, which includes the return key of the keyboard 128. As such, a user can scroll or navigate to determine an XY position on a sensing surface of the PSE and an event detected when pressure is applied to the PSE to trigger the PSD to select a desired key. Each key of the key arrangement 132, 140, 142 therefore forms a virtual button.

FIG. 20d shows an example in which the touch sensitive pad 150 is implemented using a touch sensor according to the present technique. The user can control the movement of a pointer or cursor on the display screen 122, by applying a finger to a sensing surface of a PSE forming part of the touch sensitive pad 150. When a desired position is reached, the user can engage a particular function, which is identified on the display screen 122 corresponding to that reached position by pressing on the sensing surface to register a pressure event, which is detected by the PSD. Thus the user can navigate and select a function without having to lift the finger from the sensing surface.

Various aspects and features of the present invention are defined in the appended claims. Further aspects of the present invention may include a control panel comprising a position sensing element coupled to a position interface circuit operable to determine the position of an object applied to the position sensing element, and at least one pressure sensing device below the position sensing element, wherein the pressure sensing device responds to user pressure applied at multiple locations on the user-operable user surface. The control panel may also include one or more mechanical or touch sensitive switches disposed outside of the sensing surface of the position sensing element.

According to another aspect of the present invention there is provided a method of identifying one of a plurality of user indicated signals. The method starts with a process step of determining a position of an object (100) on a sensing surface of a position sensing element (60), then sensing pressure applied to a pressure sensing device in response to a displacement of the position sensing element caused by pressure being applied to the sensing surface of the position sensing element (60) by the object (100) at the determined location, and identifying one of the plurality of user indicated signals by correlating the position of the object on the sensing surface with the pressure detected by the pressure sensing device, after which the process terminates. The step of determining the position of the object (100) on the sensing surface of a position sensing element (60), includes determining whether the object is at one of a plurality of predetermined locations on the sensing surface, and the identifying the user indicated signal includes correlating the position of the object at one of the predetermined locations with the detected pressure, each of the predetermined location corresponding to one of the plurality of user indicated signals.

According to another aspect of the present invention there is provided a method of controlling a device in response to one of a plurality of user indicated signals, the method comprising:

determining a position of an object (100) on a sensing surface of a position sensing element (60),
sensing pressure applied to a pressure sensing device in response to a displacement of the position sensing element caused by pressure being applied to the sensing surface of the position sensing element (60) by the object (100) at the determined position,
identifying one of the plurality of user indicated signals by correlating the position of the object on the sensing surface with the pressure detected by the pressure sensing device, and
controlling the device in accordance with the user indicated signal.

Optionally, the method may also include generating on a display an visual indication representing the control of the device in accordance with the user indicated signal. The method may also include generating a haptic signal in response to the identifying the user indicated signal. In other examples, the method may include the determining the position of the object (100) on the sensing surface of a position sensing element (60), including determining whether the object is at one of a plurality of predetermined locations on the sensing surface, and the identifying the user indicated signal includes correlating the position of the object at one of the predetermined locations with the detected pressure, each of the predetermined locations corresponding to one of the plurality of user indicated signals.

Another aspect of the present invention provides an apparatus for controlling a device in response to one of a plurality of user indicated signals, the apparatus comprising means for determining a position of an object (100) on a sensing surface of a position sensing element (60),

means for sensing pressure applied to a pressure sensing device in response to a displacement of the position sensing element caused by pressure being applied to the sensing surface of the position sensing element (60) by the object (100) at the determined position,
means for identifying one of the plurality of user indicated signals by correlating the position of the object on the sensing surface with the pressure detected by the pressure sensing device, and
means for controlling the device in accordance with the user indicated signal.

Various modifications may be made to the embodiments of the invention hereinbefore described without departing from the scope of the present invention.

What is claimed is:

1. A control panel comprising:
a position sensing element having a sensing surface sensitive to location of an object,
a position interface circuit operable to determine the location of an object on the sensing surface, and
at least one pressure sensing device which is responsive to a pressure event above an activation pressure threshold and which is disposed below the sensing surface of the position sensing element so as to detect a pressure event applied by the object at any position on at least part of the sensing surface.

2. A control panel as claimed in claim 1, wherein the position interface circuit in combination with the position sensing element are operable to determine the location of the object on the sensing surface when a pressure event is detected by the pressure sensing device.

3. A control panel as claimed in claim 2, wherein the position interface circuit is operable to discriminate between a plurality of user indicated signals from said location of the object on the sensing surface when said pressure event is detected by the pressure sensing device.

4. A control panel as claimed in claim 1, wherein the position interface circuit in combination with the position sensing element are operable to determine whether the object is at one of a plurality of predetermined locations on the sensing surface, and the position interface circuit is operable to identify the user indicated signal by correlating the position of the object at one of the predetermined locations with the detected pressure, each of the predetermined locations corresponding to one of the plurality of user indicated signals.

5. A control panel as claimed in claim 1, wherein the position sensing element is displace-ably mounted above the pressure sensing device on a support and the control panel includes at least one member for controlling displacement of the support between a first position, in which the support is biased by the member, and a second position in which pressure applied by the object displaces the support against a biasing force provided by the member so that pressure can be detected by the pressure sensing device.

6. A control panel as claimed in claim 5, including a deformable panel overlaying the position sensing element and wherein the support is formed from a moving platform with the effect that pressure of the object at any point on the at least part of the sensing surface of the position sensing element via the deformable panel will be detected by the pressure sensing device.

7. A control panel as claimed in claim 6, including a protective flexible membrane overlaid on the deformable panel.

8. A control panel as claimed in claim 6, including a seal gasket disposed between the deformable panel and a panel which surrounds the deformable surface.

9. A control panel as claimed in claim 1, wherein the at least one pressure sensing device is disposed at a position below and substantially in the centre of the moving platform.

10. A control panel as claimed in claim 1, wherein the at least one pressure sensing device is arranged to detect a plurality of pressures, a first of the plurality of pressures corresponding to a first pressure applied by the object and a second of the plurality of pressures corresponding to a second pressure applied by the object, the second pressure being greater than the first pressure, the plurality of pressures detected by the pressure sensing device providing a plurality of user indicated signals.

11. A control panel as claimed in claim 1, comprising a haptic interface operable in response to a user indicated signal to provide a mechanical or acoustic indication to the user that the position interface circuit has detected a user indicated signal.

12. A user controlled device comprising:
a control panel comprising a position sensing element having a sensing surface, a position interface circuit operable to determine a position of an object on the sensing surface, when the object is applied to the sensing surface of the position sensing element, and at least one pressure sensing device disposed below the sensing surface of the position sensing element so that pressure applied by the object at any position on the sensing surface can be detected by the pressure sensing device,
a display, and
an appliance controller operable in response to a user indicated signal received from the control panel to generate a representation of the signal on the display.

13. A user controlled device as claimed in claim 12, wherein the position interface circuit in combination with the position sensing element of the control panel are operable to determine a location of the object on the sensing surface when a pressure event is detected by the pressure sensing device.

14. A user controlled device as claimed in claim 12, wherein the position interface circuit is operable to identify one or more of a plurality of user indicated signals by correlating the position of the object on the sensing surface with a pressure event detected by the pressure sensing device, and the appliance controller is operable to generate a representation of the one or more user indicated signals on the display screen.

15. A control panel for controlling a device in response to user indications, the control panel comprising:
a position sensing element having a sensing surface,
a position interface circuit or an appliance controller operable to determine a position of an object on the sensing surface, when the object is applied to the sensing surface of the position sensing element, and at least one pressure sensing device, wherein the pressure sensing device and the sensing surface of the position sensing element are arranged with the effect that a displacement of the sensing surface with respect to the pressure sensing device in response to the pressure applied by the object is detectable by the pressure sensing device.

16. A control panel as claimed in claim 15, wherein the position interface circuit or an appliance controller is operable to identify one or more of a plurality of user indicated signals by correlating the position of the object on the sensing surface with a pressure detected by the pressure sensing device.

17. A control panel as claimed in claim 15, wherein the position interface circuit or the appliance controller is operable to determine whether the object is at one of a plurality of predetermined locations on the sensing surface of the position sensing element, and the position interface circuit or the appliance controller is operable to identify the user indicated signal by correlating the position of the object at one of the predetermined locations with the detected pressure, each of the predetermined location corresponding to one of the plurality of user indicated signals.

18. A control panel as claimed in claim 15, comprising a resiliently compressible member operatively connected to a support on which the position sensing element is disposed, wherein the pressure applied by the object to the sensing surface of the position sensing element causes the displacement of the sensing surface against a restorative force provided by the resiliently compressible member which is detectable by the pressure sensing device.

19. A method of identifying one of a plurality of user indicated signals, the method comprising:
determining a position of an object on a sensing surface of a position sensing element,
sensing pressure applied to a pressure sensing device in response to a displacement of the position sensing element caused by pressure being applied to the sensing surface of the position sensing element by the object at the determined location, and
identifying one of the plurality of user indicated signals by correlating the position of the object on the sensing surface with the pressure detected by the pressure sensing device.

20. A method as claimed in claim 19, wherein the determining the position of the object on the sensing surface of a position sensing element, includes determining whether the object is at one of a plurality of predetermined locations on the sensing surface, and the identifying the user indicated signal includes correlating the position of the object at one of the predetermined locations with the detected pressure, each of the predetermined locations corresponding to one of the plurality of user indicated signals.

21. An apparatus for identifying one of a plurality of user indicated signals, the apparatus comprising:
means for determining a position of an object on a sensing surface of a position sensing element,
means for sensing pressure applied to a pressure sensing device in response to a displacement of the position sensing element caused by pressure being applied to the sensing surface of the position sensing element by the object at the determined location, and
means for identifying one of the plurality of user indicated signals by correlating the position of the object on the sensing surface with the pressure detected by the pressure sensing device.
